(19) United States
(12) Patent Application Publication
(10) Pub. No.: US 2019/0266282 A1
(43) Pub. Date: Aug. 29, 2019

(54) SYSTEMS AND METHODS FOR CONSTRAINED DIRECTED MEDIA SEARCHES

(71) Applicant: Ent. Services Development Corporation LP, Houston, TX (US)

(72) Inventors: Guy Mitchell, Aurora, CO (US); Babak Makkinejad, Troy, MI (US)

(21) Appl. No.: 15/907,675

(22) Filed: Feb. 28, 2018

(51) Int. Cl. G06F 17/30; G06N 99/00

(52) U.S. Cl. CPC G06F 17/30793; G06N 99/005; G06F 17/30867

(57) ABSTRACT

Systems, methods, and non-transitory computer readable media configured to receive a first media item from a search engine. One or more seed data items can be generated from the first media item. Further, a search query can be generated. The search query can include one or more of the seed data items. Subsequently, the search query can be provided to the search engine.

### FIELD OF THE INVENTION

The present technology relates to the field of computerized search. More particularly, the present technology relates to techniques for performing constrained directed media searches.

### BACKGROUND

Users often utilize computing devices for a wide variety of purposes. For example, users can use their computing devices to search for media items. In searching for media items, a user typically submits a search query to a search engine. The search query can specify one or more terms. In response, the search engine looks for media items which satisfy the query. Subsequently, the search engine can provide the media items to the user.

### SUMMARY

Various embodiments of the present disclosure can include systems, methods, and non-transitory computer readable media configured to receive a first media item from a search engine. One or more seed data items can be generated from the first media item. Further, a search query can be generated. The search query can include one or more of the seed data items. Subsequently, the search query can be provided to the search engine.

In an embodiment, the first media item can be determined to depict a target person.

In an embodiment, a user indication of the one or more seed data items generated for the first media item can be provided.

In an embodiment, a user indication of one or more seed data items which led to discovery of the first media item can be provided.

In an embodiment, an audio media item and one or more image media items can be generated from the first media item.

In an embodiment, the generating the one or more seed data items can comprise recognizing, within the first media item, one or more of a hand signal or a body movement. The generating the one or more seed data items can further comprise generating a description of the one or more of the hand signal or the body movement.

In an embodiment, a further media item can be received from the search engine. The further media item can be received in reply to the search query. One or more further seed data items can be generated from the further media item. Also, a further search query can be generated. The further search query can include one or more of: the seed data items generated from the first media item, or the further seed data items. Subsequently, the further search query can be provided to the search engine.

In an embodiment, the further media item can be determined to depict a target person, wherein the further media item does not include a tag identifying the target person.

In an embodiment, the one or more seed data items generated for the first media item can be stored in a repository.

In an embodiment, the generating the search query can comprise providing one or more of the seed data items to a machine learning model. The generating the search query can further comprise receiving an output from the machine learning model. The output can specify one or more seed data items.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a directed media search module, according to an embodiment of the present disclosure.

FIG. 2 illustrates an example functional block diagram, according to an embodiment of the present disclosure.

FIG. 3 illustrates a further example functional block diagram, according to an embodiment of the present disclosure.

FIG. 4 illustrates an example process, according to an embodiment of the present disclosure.

FIG. 5 illustrates a further example process, according to an embodiment of the present disclosure.

FIG. 6 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Approaches for Constrained Directed Media Searches

Users often utilize computing devices for a wide variety of purposes. For example, users can use their computing devices to search for media items. In searching for media items, a user typically submits a search query to a search engine. The search query can specify one or more terms. In response, the search engine looks for media items which satisfy the query. Subsequently, the search engine can provide the media items to the user.

For example, a user can desire to use a search engine to locate media items which depict a person. Such a user typically desires to locate as many of these media items as possible. However, according to conventional approaches, the search engine typically only returns media items which satisfy a submitted query. As one illustration, the search engine might return only media items having tagging which satisfies the query. In some instances, a media item can depict a person but not include tags or other information expressly identifying that person. As an illustration, a media item that is a historical video might depict a famous person standing or interacting with other people. The media item might include tags which identify the famous person, but might not include tags which identify the other people. A user, seeking media items which depict one of the other people, might consider this media item to be a useful search result. However, due to the lack of tagging for all depicted individuals other than the famous person, a search engine operating according to conventional approaches would typically not return this media item.

Moreover, according to conventional approaches, search functionality typically ends for a user after responding to a search query submitted by that user. Results returned in reply to the search query might include information useful in subsequent searches. However, according to conventional approaches, the user typically receives little or no guidance in locating such information, much less guidance in formulating such subsequent searches. Without such guidance, the user might fail recognize the information or to perform such subsequent searches.

Due to these or other concerns, such conventional approaches specifically arising in the realm of computer technology can be disadvantageous or problematic. Therefore, an improved approach can be beneficial for addressing or alleviating various drawbacks associated with conventional approaches. Based on computer technology, the disclosed technology can perform a search for media items in an effective manner. In some embodiments, a user can already possess a media item which depicts a target person that is identified by the user. The user can also perform an initial search to locate media items depicting the target person. In doing so, the user can formulate a search query which includes one or more terms relating to the target person. The search query can be submitted to a search engine. This can result in the return of one more media items. Operations can be performed to determine whether or not the media items depict the target person.

Also, operations can be performed to recognize seed data items within the media items. Certain of these seed data items can be selected for use in further searches. Search queries which include the selected seed data items can be formulated. The search queries can be submitted to the search engine. This can result in the search engine returning further media items. Various of the discussed operations can be performed with respect to the further media items. In this way, operation can proceed onward, with further seed data items being recognized, and with further media items depicting the target person being found. Media items which depict the target person can be presented to the user. In some embodiments, selected seed data items can also be presented to the user. Although a person is sometimes referenced in relation to a target in various examples discussed herein, the present disclosure applies equally well to other kinds of targets. As one example, the functionality discussed herein is also applicable to a target vehicle. For instance, the target vehicle can be a stolen vehicle or a vehicle which was witnessed near a crime scene. As another example, the functionality discussed herein is also applicable to a target animal, such as a lost pet. More generally, the functionality discussed herein is applicable to a target which is a particular instance of a given class. As an illustration, the class can be “human” and the target instance can be a particular “John Smith.” Many variations are possible.

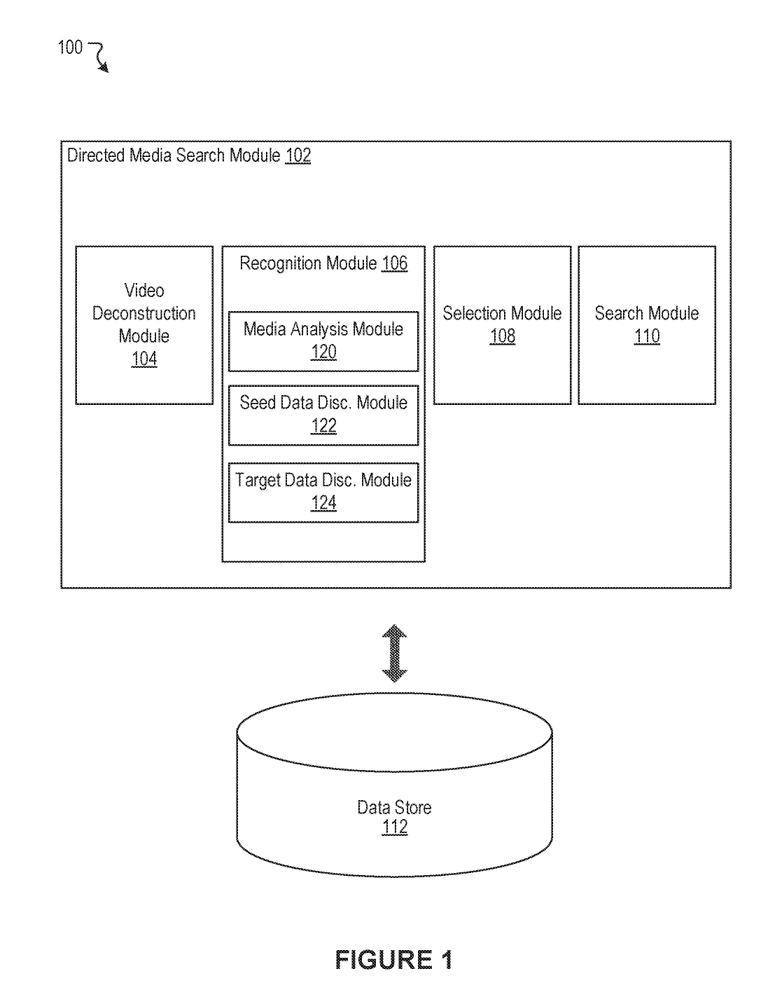

FIG. 1 illustrates an example system 100 including an example directed media search module 102, according to an embodiment of the present disclosure. As shown in the example of FIG. 1, the directed media search module 102 can include a video deconstruction module 104, a recognition module 106, a selection module 108, and a search module 110. In some instances, the example system 100 can include at least one data store 112. The components (e.g., modules, elements, etc.) shown in this figure and all figures herein are exemplary only, and other implementations can include additional, fewer, integrated, or different components. Some components may not be shown so as not to obscure relevant details.

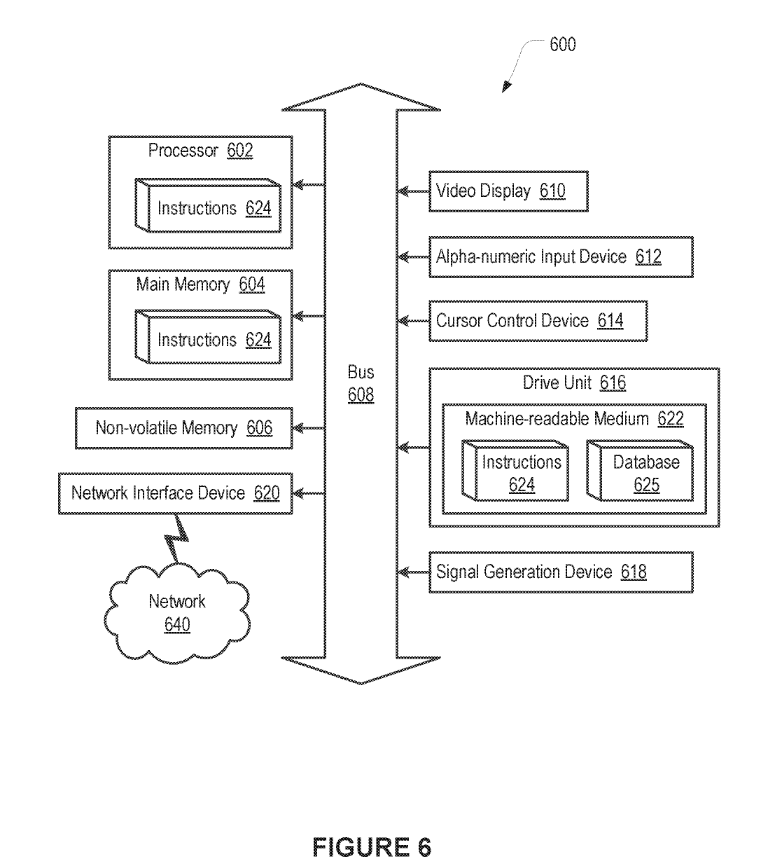

In some embodiments, the directed media search module 102 can be implemented, in part or in whole, as software, hardware, or any combination thereof. In some cases, the directed media search module 102 can be implemented, in part or in whole, as software running on one or more computing devices or systems. For example, the directed media search module 102 or at least a portion thereof can be implemented using one or more computing devices or systems that include one or more servers, such as network servers or cloud servers. In another example, the directed media search module 102 or at least a portion thereof can be implemented as or within an application (e.g., app), a program, an applet, or an operating system, etc., running on a user computing device or a client computing system. The directed media search module 102 or at least a portion thereof can be implemented using computer system 600 of FIG. 6. It should be understood that there can be many variations or other possibilities.

One or more machine learning models discussed in connection with the directed media search module 102 and its components can be implemented separately or in combination, for example, as a single machine learning model, as multiple machine learning models, as one or more staged machine learning models, as one or more combined machine learning models, etc.

The directed media search module 102 can be configured to communicate and/or operate with the at least one data store 112, as shown in the example system 100. The at least one data store 112 can be configured to store and maintain various types of data. For example, the data store 112 can store information used or generated by the directed media search module 102. The information used or generated by the directed media search module 102 can include, for example, target data, seed data, and training data.

Where a media item is, in particular, a video media item, the video deconstruction module 104 can be used. The video deconstruction module 104 can receive a video media item. The video deconstruction module 104 can utilize conventional approaches to produce an audio media item and image media items from the video media item. The audio media item can correspond to the audio track of the video media item. Each of the image media items can correspond to a frame of the video media item. In some embodiments, the video deconstruction module 104 can produce image media items with respect to only certain frames of the video media item. As an example, the number of frames for which media items are produced can be based on the running time of the video media item at a particular frame rate.

The recognition module 106 can include a media analysis module 120, a seed data discovery module 122, and a target data discovery module 124. The media analysis module 120 of the recognition module 106 can perform speech recognition. The speech recognition can utilize or be based on conventional approaches. The speech recognition can be used by the recognition module 106 to generate text from audio data of a media item. The media analysis module 120 of the recognition module 106 can also perform text recognition. The text recognition can utilize or be based on conventional approaches. The text recognition can be used by the recognition module 106 to generate text from image data of a media item.

Furthermore, the media analysis module 120 of the recognition module 106 can perform facial detection. The facial detection can utilize or be based on conventional approaches. The facial detection can be used by the recognition module 106 to recognize the presence of a face in image data of a media item. The media analysis module 120 of the recognition module 106 can additionally perform facial recognition. The facial recognition can, for a detected face, utilize a trained machine learning model to return a name or other identifier, such as a name or identifier expressed in text, of a person who corresponds to the face. The facial recognition can also indicate whether or not a detected face matches a face depicted by one or more specified images. The facial recognition can utilize conventional approaches. The facial recognition can be used, for instance, by the recognition module 106 to generate identities of people from image data of a media item.

Further still, the media analysis module 120 of the recognition module 106 can perform hand signal recognition. The hand signal recognition can utilize or be based on a trained machine learning model to return a description, such as a textual description, for a hand signal appearing in an image, or in a series of images. The descriptions can, as examples, include descriptions of hand signals used in sports, dance, conversation, work, driving, criminal acts, military, police, and emergency contexts. In some embodiments, the descriptions can include culture-specific descriptions. Many variations are possible. The hand signal recognition can utilize or be based on conventional approaches, such as conventional gesture recognition approaches. The hand signal recognition can be used by the recognition module 106 to generate descriptions of hand signals from image data of a media item.

Also, the media analysis module 120 of the recognition module 106 can perform body movement recognition. The body movement recognition can utilize or be based on a trained machine learning model to return a description, such as a description expressed as text, for a body movement appearing in an image, or in a series of images. The descriptions can include descriptions of body movements regarding sports, dance, conversation, work, driving, criminal acts, military operations, police operations, and emergency operations. In some embodiments, the descriptions can include culture-specific descriptions. In these embodiments, the trained machine learning model might accept a specification of a region as one of its inputs. Subsequently, the machine learning model might take into account both a body movement and a specified region in returning a description. As one illustration, where the machine learning model receives an indication of a nod body movement along with a region indication of Greece, the machine learning model might return a description which indicates a “no.” However, when receiving an indication of a nod body movement along with a region indication of North America, the machine learning model might return a description which indicates a “yes.” Many variations are possible. The body movement recognition can utilize or be based on conventional approaches. The body movement recognition can be used by the recognition module 106 to generate descriptions of body movements from image data of a media item.

Moreover, the media analysis module 120 of the recognition module 106 can perform facial age progression and facial age regression. The age progression and age regression can utilize or be based on conventional approaches. The age progression and age regression can be used by the recognition module 106 to transform image data which depicts a face at a first chronological age into image data which depicts a prediction of the face at a second chronological age.

The seed data discovery module 122 of the recognition module 106 can process a received media item and return one or more seed data items. The media item can be found via a search query. The seed data items can be available for use as search terms in a subsequent search query. As one example, a seed data item can be text which can be used as a search term for a search engine which accepts textual input. As another example, a seed data item can be an image which can be used as a search term for a search engine which accepts image input. The seed data discovery module 122 can utilize the media analysis module 120 of the recognition module 106 in performing the processing.

The seed data discovery module 122 can utilize the media analysis module 120 to receive names, identifiers, descriptions, or other information which reflects image data and/or audio data of the media item. As an example, this can cause the seed data discovery module 122 to receive spoken words of the media item in text form. As another example, utilizing the media analysis module 120 can cause the seed data discovery module 122 to receive pictured words of the media item in text form. Accordingly, as one illustration, where a media item includes image data depicting a billboard, uniform, or sport team banner, the seed data discovery module 122 can receive words of the billboard, uniform, or banner in text form.

Based on the media analysis module 120, the seed data discovery module 122 can receive names or other identifiers of people depicted in the media item. In particular, the names or other identifiers of people depicted in the media item can be determined by facial recognition performed by the media analysis module 120. Additionally, based on the media analysis module 120, the seed data discovery module 122 can receive descriptions of hand signals and/or body movements depicted in the media item.

Further to the names, identifiers, descriptions, and other information received via the media analysis module 120, the seed data discovery module 122 can have access to data of the media item which is natively in text form. The data which is natively in text form can include metadata tags. The data which is natively in text form can also include text associated with the media item. For example, such text can include text which accompanies the media item in a web page which presents the media item.

As such, the seed data discovery module 122 can have access to a pool of names, identifiers, descriptions, and other information corresponding to the image data and/or audio data of a media item. The seed data discovery module 122 can identify seed data items within the pool. The seed data items identified by the seed data discovery module 122 can be of multiple types. The types can be applicable to a kind of target with respect to which the directed media search module 102 is operating. As examples, the types can include date, person, activity, organization, event, and location. The seed data discovery module 122 can identify as seed data items, in the pool, seed data items of one or more of the types. The seed data items can be stored in a repository.

In some embodiments, identifying seed data items of type date in the pool can be performed via conventional text processing approaches. The approaches can include, for example, approaches which utilize regular expressions to identify date formats. This can result in seed data items of type date.

In some embodiments, identifying seed data items of type person in the pool can be performed via conventional text processing approaches, including approaches which compare text found in the pool to first and last names found in a names database. As one example, the database can be a names database provided by the US Census Bureau or the Social Security Administration. Matches between information found in the pool and names in the names database can result in seed data items of type person. In some embodiments, identifying seed data items of type person in the pool can include using conventional text processing approaches to compare text found in the pool to a database of descriptions of people. The conventional text processing approaches can include approaches which ascertain semantic similarity between words and/or phrases. The database can include phrases describing physical attributes. For instance, the database can include the phrase “he was tall and thin.” The database can also include phrases describing personal actions and habits. For instance, the database might include the phrase “he wore yellow pants and a big hat.” The database might be compiled using phrases drawn from literature, police reports, or newspaper articles. Many variations are possible. Determined matches between information found in the pool, and text, phrases, and other information in the database, can result in further seed data items of type person.

In some embodiments, identifying seed data items of type activity, seed data items of type organization, or seed data items of type event in the pool can be performed via conventional text processing approaches, including approaches which compare text found in the pool to one or more databases. Such databases can include words and phrases which generally describe activities, organization, and events. With regard to activities, as examples, words and phrases generally regarding hobbies and professions can be included. With regard to organizations, as examples, words and phrases generally regarding clubs, companies, teams, and societies can be included. With regard to events, as examples, words and phrases generally regarding happenings and life events can be included. As illustrations, “born,” “married,” “died,” and “baseball game” might be included. Moreover, words and phrases which particularly describe specific activities, organizations, and/or events can be included in the databases. As illustrations, included might be “2nd Calvary Regiment” and “Super Bowl VIII.” In some embodiments, identifying seed data items of type activity, seed data items of type organization, or seed data items of type event in the pool can include using approaches which ascertain semantic similarity between words and/or phrases. Determined matches between information found in the pool, and text, phrases, and other information in the databases, can result in seed data items of type activity, seed data items of type organization, and/or seed data items of type event.

In some embodiments, identifying seed data items of type location in the pool can be performed via conventional text processing approaches, including approaches which compare text found in the pool to location names found in one or more location names databases. The location names can include geographical names such as names of countries, states, provinces, and cities. The location names can also include place names such as places of business, schools, transit centers, and medical facilities. As examples, the databases can include the GeoNames database and/or the OpenStreetMap Nominatim database. In some embodiments, regular expressions and/or other conventional text processing approaches can be employed to identify geographical coordinates in the pool. The discussed operations can result in seed data items of type location.

In addition to identifying seed data items of type person in the pool, the seed data discovery module 122 can utilize the media analysis module 120 to receive images of faces of people depicted in a media item. In particular, the seed data discovery module 122 can receive the images of faces of depicted people in connection with the media analysis module 120 applying the facial detection to the media item. The seed data discovery module 122 can use the images of faces of people as seed data items of type person.

In some embodiments, the seed data types can be more broadly or more narrowly delineated. As examples, as an alternative to or in addition to the person seed data type, there can be a serviceman/servicewoman seed data type, an employee seed data type, and/or a family member seed data type. As further examples, as an alternative to or in addition to the event seed data type, there can be a sporting event seed data type and/or a life event seed data type. In these embodiments, identifying seed data items of these types can, for instance, include having conventional text processing approaches access databases which include words, phrases, and other information corresponding to these seed data types. Determined matches between the words, phrases, and other information of the databases, and information found in the pool, can result in seed data items of these seed data types. As an illustration, with respect to the serviceman/servicewoman seed data type, the words and phrases might include “sailor,” “airman,” “airwoman,” and/or “soldier.” Many variations are possible.

In some embodiments, where the seed data discovery module 122 does not identify any seed data items of type date in the pool, the seed data discovery module 122 can utilize the facial recognition of the media analysis module 120 to ascribe one or more dates to the media item. In particular, the seed data discovery module 122 can have access to one or more dated images of a person depicted in the media item. The dated images of the person can include true dated images of the person. In some embodiments, the dated images of the person can also include synthetic dated images of the person. The synthetic dated images of the person can be the product of the age progression and the age regression performed by the media analysis module 120. The synthetic dated images can have been created for chronological time periods for which no true dated image of the person was possessed. The seed data discovery module 122 can utilize the facial recognition to attempt to match the dated images to the depiction of the person. Where one of the dated images achieves match, the seed data discovery module 122 can consider the date of the matching image to be a seed data item of type date for the media item.

In some embodiments, dated images of a person, both true and synthetic, can be stored in the context of a timeline. For example, such an image can be stored in the timeline along with a corresponding seed data item of type date or a seed data item of type location. As an illustration, a particular image of the timeline might be stored along with location a seed data item specifying a particular city and/or a seed data item specifying a particular hotel, and with a seed data item of type date specifying a particular date. Many variations are possible.

In some embodiments, the seed data discovery module 122 retains only certain seed data items. In these embodiments, a user performing a search can specify one or more dates, people, activities, organizations, events, and/or locations. Subsequently, the seed data discovery module 122 can retain seed data items which correspond to these dates, people, activities, organizations, events, and/or locations. As one example, the user can make the specification in a categorical fashion. As an illustration, the user might specify a yearbook, a directory, a military group, and/or or a sports team. The seed data discovery module 122 can have access to listings of the people included in the yearbook or the directory, or affiliated with the military group or sports team. The specification by the user can cause the seed data discovery module 122 to retain seed data items which correspond to the indicated or affiliated people. As another example, the user can make the specification in an itemized way. As an illustration, the user might specify one or more particular people. Many variations are possible.

The target data discovery module 124 of the recognition module 106 can determine whether or not a received media item depicts a person who is a target of a search. The media item can be an image media item corresponding to an image found via a search. The image media item can also be a frame of a video media item found via a search. The target data discovery module 124 can use the facial detection and the facial recognition of the media analysis module 120 in the determination.

The target data discovery module 124 can use the facial detection of the media analysis module 120 to detect one or more faces depicted in the media item. The target data discovery module 124 can subsequently use the facial recognition of the media analysis module 120 to attempt to match images of the target person already possessed by a user against the detected face. Where one or more matches occur, the target data discovery module 124 can determine the media item to contain target data. This can cause the target data discovery module 124 to determine the media item to depict the person who is the target of the search.

In some embodiments, the possessed images of the target person can depict the person at different ages. This can allow for recognition of the target person across multiple points in the life of the person. The images depicting the person at different ages can include both true images and synthetic images created via the age progression and/or the age regression of the media analysis module 120. Also, in some embodiments, the images depicting the person at different ages can be stored in a timeline in the manner discussed.

The selection module 108 can receive seed data items discovered for a media item. The selection module 108 can generate a search query. The generated search query can include selected seed data items discovered for the media item. In some embodiments, the generated search query can also include selected, previously-discovered seed data items. Further still, in some embodiments, the generated search query can include chosen Boolean operators.

In some embodiments, the selection module 108 can utilize a machine learning model in generating the search query. As one example, the machine learning model can be a reinforcement learning-based machine learning model. A reinforcement learning machine learning model can operate in an attempt to maximize receipt of a reward. In pursuit of the reward, the machine learning model can select from among different available actions. Executing a selected action can cause a transition from a present state to a new state. For the reinforcement learning-based machine learning model of the selection module 108, a reward can, as an example, be locating a seed data item. As another example, a reward can be locating a media item which depicts a target person. Further for the machine learning model, the actions can be search queries. A state can correspond to a most recently found media item and/or previously found media items. Alternately or additionally, a state can correspond to most recently found and/or previously found seed data items and targets. Many variations are possible. As an illustration, the seed data items available to the machine learning model at a present state might include a seed data item of type date, a seed data item of type person, and a seed data item of type event. In this illustration, the available actions could correspond to the different search queries employing, as search terms, the seed data items of the three types. Many variations are possible. During a learning phase, the machine learning model can be given multiple searches for target people to perform. After finishing the learning phase, the machine learning model can be used by the selection module 108 to generate search queries.

In some embodiments, the selection module 108 can provide a dialog to a user performing a search. The dialog can be provided to the user via a user interface presented on a computing device of the user. The dialog can present to the user seed data items discovered for a media item. In some embodiments, the dialog can also present previously-discovered seed data items. The dialog can ask the user to select one or more of the seed data items for use in a search query for a subsequent search. In some embodiments, the dialog can allow the user to select Boolean operators for the search query. Subsequently, the selection module 108 can generate a search query which corresponds to the selections of the user.

Such selections of a user relating to seed data items and Boolean operators can, in some embodiments, be used by the selection module 108 in constructing instances of training data. In particular, an instance of training data can include, as training data input, feature data for a media item. The instance of training data can include, as training data output, the selections of the user for the media item. The selection module 108 can construct a training data set made up of multiple such instances of training data. Subsequent to creating a training data set, the selection module 108 can use the training data set to train a machine learning model. As one example, the machine learning model can be a neural network-based multilabel classifier or other multilabel classifier. Once trained, the selection module 108 can provide the machine learning model with feature data for a media item. In return, the selection module 108 can receive selections of seed data items from the machine learning model. In some embodiments, the selection module 108 can also receive corresponding Boolean operators. The selection module 108 can use the output of the machine learning model to generate a search query.

In some embodiments, the selection module 108 can return multiple search queries for a single media item. As an illustration, where three seed data items were available for selection by the selection module 108, the selection module 108 might generate two search queries. The first search query might specify the first and the third of the seed data items. The second query might specify the second of the seed data items. In these embodiments, the reinforcement learning-based model might be permitted to perform actions which provide for multiple search queries for a single media item. Also in these embodiments, the multilabel classifier-based machine learning model might receive training data instances which correspond to the selection of multiple queries for a single media item. Further still, in these embodiments, a user might be able to specify information for multiple search queries for a single media item. Many variations are possible.

The search module 110 can perform a search for media items which depict a target person. A user can have uploaded one or more images of the target person. Also, the user can have located one or more images of the target person through searches. Further still, in some embodiments the search module 110 can provide a user interface which allows a user to create a synthetic image of the target person. In these embodiments, the search module 110 can utilize conventional approaches to allow a user to formulate the synthetic image as a sketch or 3D model which resembles the target person. The search module 110 can subsequently use the synthetic image as an image of the target person. Many variations are possible.

The search module 110 can receive a search query. The search query can have been entered by the user via the user interface. The user can have selected one or more search terms for the search query. Alternatively, the search query can have been generated by the selection module 108 during prior operation of the search module 110. The search module 110 can provide the search query to a search engine. In reply, the search module 110 can receive one or more media items. The media items can include audio media items, video media items, and image media items. Where a received media item is a video media item, the search module 110 can provide the media item to the video deconstruction module 104. This can cause the search module 110 to receive an audio media item and one or more image media items. The search module 110 can perform multiple operations with respect to each of the media items received from the video deconstruction module 104. The search module 110 can also perform these operations with respect to each of the audio media items and image media items received from the search engine.

In particular, the search module 110 can provide each such media item to the recognition module 106. In reply, where the media item is an image media item, the search module 110 can receive indication of whether or not the media item depicts the target person. Also in reply, the search module 110 can receive seed data items for the media items. For each media item, the search module 110 can provide the corresponding seed data items to the selection module 108. Where the media item depicts the target person, the search module 110 can provide the media item to the user via the user interface. In some embodiments, the user can also be provided with seed data items recognized for the media item.

The search module 110 can receive a reply from the selection module 108. The reply can provide a search query. The search module 110 can provide the search query to the search engine. The search module 110 can receive one or more media items in reply. The search module 110 can repeat the discussed operations with respect to these media items. In some embodiments, where a subsequent search finds a media item which depicts the target person, providing the media item to the user can also include informing the user of one or more of the seed data items which led to the discovery of the media item. Moreover, in some embodiments, a search depth limit can be set by the user or by a system administrator. This can cause there to be a limit on the number iterations performed by the search module 110 or the number of media items operated upon by the search module 110. The limit can be any suitable number, such as two, three, ten, fifty, etc. There can be many variations or other possibilities.

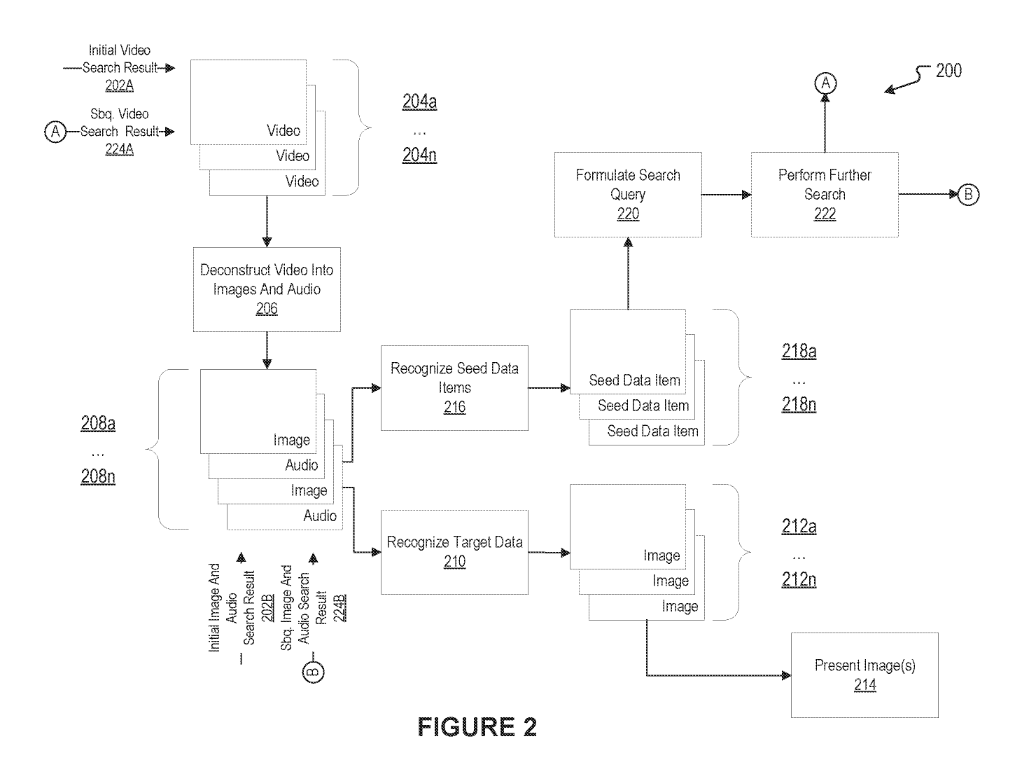

FIG. 2 illustrates an example functional block diagram 200, according to an embodiment of the present disclosure. The example functional block diagram 200 illustrates a directed search for media depicting a target person, according to an embodiment of the present disclosure. A user can have uploaded one or more images of the person or have found one or more images of the person via searching. An initial search can be performed by the user. The initial search can return initial video search result 202A. The initial video search result 202A can provide video media items 204a-204n. At block 206, the video media items 204a-204n can be deconstructed into image media items and audio media items. The image media items and audio media items resulting from the deconstruction can contribute to the image media items and audio media items 208a-208n. The initial search can also return initial image and audio search result 202B. The initial image and audio search result 202B can also contribute to image media items and audio media items 208a-208n.

At block 210, for each of the image media items of the image media items and audio media items 208a-208n, a determination can be made as to whether or not the image media item depicts the target person. This can result in identification of image media items 212a-212n which depict the target person. At block 214, these image media items can be presented to the user.

At block 216, via a recognition operation, seed data items can be returned for one or more of image media items and audio media items 208a-208n. This can result in seed data items 218a-218n. At block 220, for each of those image media items and audio media items, a selection operation can be performed. The selection operation performed with respect to a given image media item or audio media item can generate a search query which can include one or more of the seed data items returned for that image media item or audio media item. This can result in one or more search queries. At block 222, these search queries can be used in performing further searches. This can return subsequent video search result 224A and subsequent image and audio search result search result 224B. Then, the discussed operations can be repeated with respect to the media items provided by subsequent video search result 224A, and by subsequent image and audio search result search result 224B. In various embodiments, functionality of the functional block diagram 200 can include some or all functionality of the directed media search module 102.

As an illustration, a user can upload a picture of a target person, a family relative who was a player on a baseball team in the past. The user might perform an initial search using a search query which specifies the name of the relative, the word “baseball,” and the word “player.” This can result in the return of one or more media items which match the query. Among these media items can be a video media item which includes a metadata tag which matches the name of the relative. The video media item might have a frame depicting a banner which states a city name. The audio track of the video might mention a name of a society. By the discussed functionality, the city name and the name of the society can be recognized as seed data items. Also, as discussed, a search query can be formulated which specifies the city name and the society name as search terms. The search might return multiple media items, including a video media item. The returned multiple media items might not be tagged with or otherwise specify the name of the relative. The video media item might depict a gesture used by a catcher in baseball. As discussed, the gesture can be recognized as a seed data item.

In this illustration, a further search query might be formulated. The further search query can specify the new seed data item of the gesture and the previous seed data item of the city name. The further search can return multiple media items including an image media item. The image media item might not be tagged with or otherwise specify the name of the relative. The image media item can depict a baseball player and an imaged text label. The imaged text label can state the name of a baseball team and the phrase “our catcher.” By way of the discussed functionality, the name of the team and the profession of catcher can be recognized as seed data items. Also, as discussed, the image media item can be found to depict the relative.

Subsequently, the media item can be presented to the user. Also presented to the user can be one or more of the seed data items which led to the discovery of the media item, or which were recognized for the media item. This can cause the user to receive indication of seed data items including the city name, the society, the team name, and the profession of catcher. While the foregoing has been provided as an illustration, many variations are possible in accordance with the present technology.

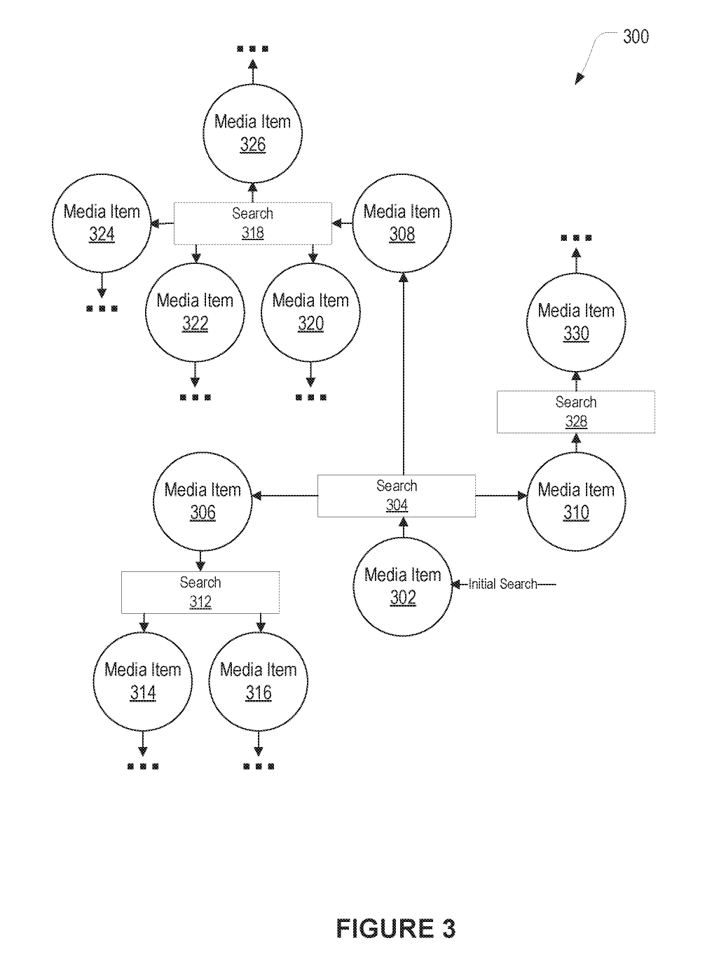

FIG. 3 illustrates an example functional block diagram 300, according to an embodiment of the present disclosure. A user, seeking media items which depict a target person, can provide an initial search query to a search engine. The search engine can return one or more media items. Among these media items can be media item 302. A recognition operation can return one or more seed data items for media item 302. Subsequently, a selection operation can be performed. This can result in a search query which includes one or more of the seed data items. At block 304, the search query can be provided to the search engine. The search engine can return media items 306, 308, and 310.

The recognition operation and the selection operation can be performed for media item 306. This can result in a search query for media item 306. At block 312, the search query can be provided to the search engine. The search engine can return media items 314 and 316. The operations discussed with respect to media item 306 can be performed with respect to media items 314 and 316. Similarly, the recognition operation and the selection operation can be performed for media item 308. This can result in a search query for media item 308. At block 318, the search query can be provided to the search engine. The search engine can return media items 320, 322, 324, and 326. The discussed operations can be performed with respect to media items 320, 322, 324, and 326. Also similarly, the recognition operation and the selection operation can be performed for media item 310. This can result in a search query for media item 310. At block 328, the search query can be provided to the search engine. The search engine can return media item 330. The discussed operations can be performed with respect to media item 330.

As such, increasingly further search operations can be performed. In some embodiments, the search operations can proceed until a search depth limit is reached. While the foregoing has been provided as an illustration, many variations are possible in accordance with the present technology. In various embodiments, functionality of the functional block diagram 300 can include some or all functionality of the directed media search module 102.

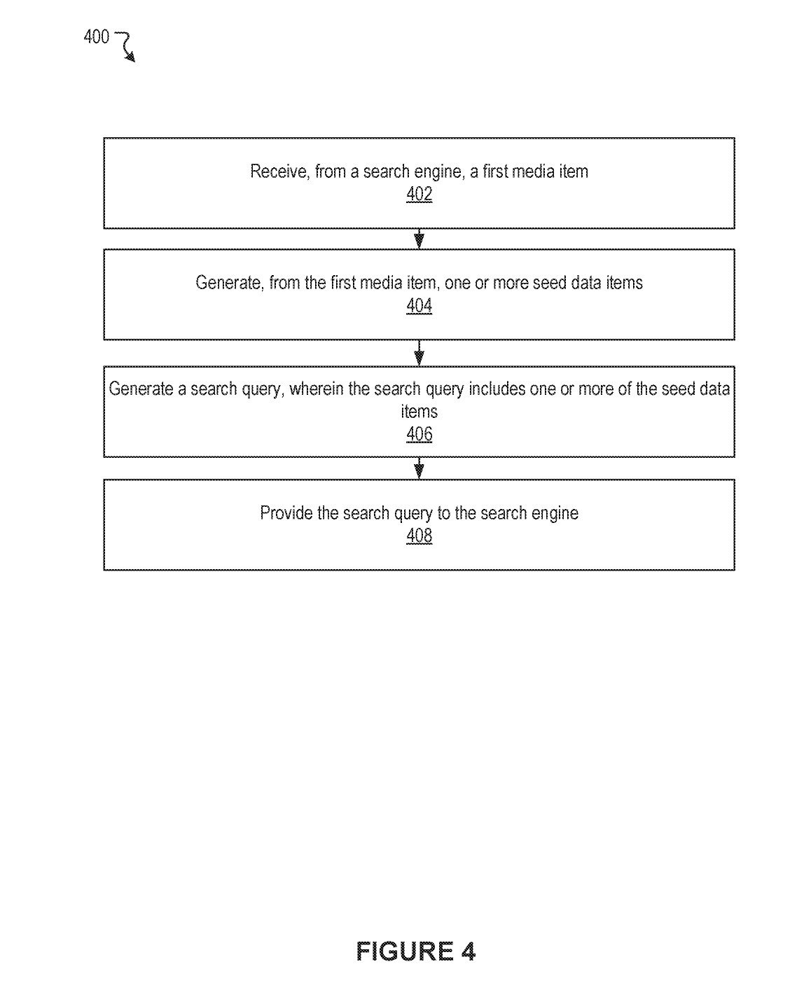

FIG. 4 illustrates an example process 400, according to various embodiments of the present disclosure. It should be appreciated that there can be additional, fewer, or alternative steps performed in similar or alternative orders, or in parallel, within the scope of the various embodiments discussed herein unless otherwise stated.

At block 402, the example process 400 can receive, from a search engine, a first media item. At block 404, the process can generate, from the first media item, one or more seed data items. At block 406, the process can generate a search query, wherein the search query includes one or more of the seed data items. Then, at block 408, the process can provide the search query to the search engine.

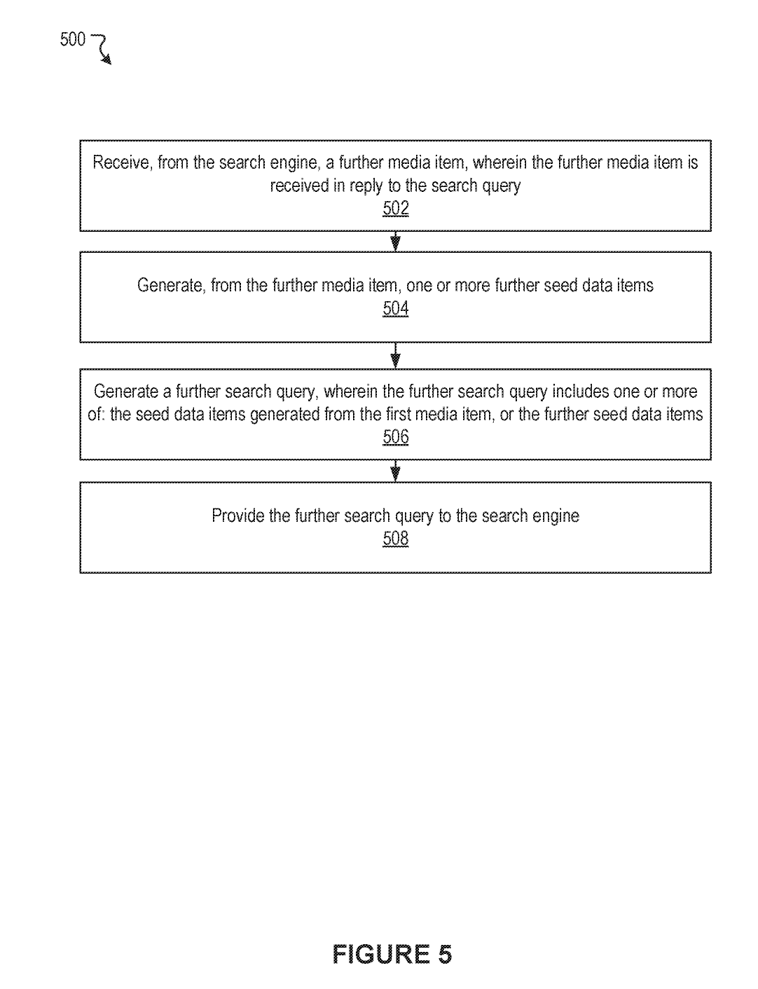

FIG. 5 illustrates an example process 500, according to various embodiments of the present disclosure. It should be appreciated that there can be additional, fewer, or alternative steps performed in similar or alternative orders, or in parallel, within the scope of the various embodiments discussed herein unless otherwise stated.

At block 502, the example process 500 can receive, from the search engine, a further media item, wherein the further media item is received in reply to the search query. At block 504, the process can generate, from the further media item, one or more further seed data items. At block 506, the process can generate a further search query, wherein the further search query includes one or more of: the seed data items generated from the first media item, or the further seed data items. Then, at block 508, the process can provide the further search query to the search engine.

It is contemplated that there can be many other uses, applications, and/or variations associated with the various embodiments of the present disclosure. For example, various embodiments of the present disclosure can learn, improve, and/or be refined over time.

### Hardware Implementation

The foregoing processes and features can be implemented by a wide variety of machine and computer system architectures and in a wide variety of network and computing environments. FIG. 6 illustrates an example of a computer system 600 that may be used to implement one or more of the embodiments described herein according to an embodiment of the invention. The computer system 600 includes sets of instructions 624 for causing the computer system 600 to perform the processes and features discussed herein. The computer system 600 may be connected (e.g., networked) to other machines and/or computer systems. In a networked deployment, the computer system 600 may operate in the capacity of a server or a client machine in a client-server network environment, or as a peer machine in a peer-to-peer (or distributed) network environment.

The computer system 600 includes a processor 602 (e.g., a central processing unit (CPU), a graphics processing unit (GPU), or both), a main memory 604, and a nonvolatile memory 606 (e.g., volatile RAM and non-volatile RAM, respectively), which communicate with each other via a bus 608. In some embodiments, the computer system 600 can be a desktop computer, a laptop computer, personal digital assistant (PDA), or mobile phone, for example. In one embodiment, the computer system 600 also includes a video display 610, an alphanumeric input device 612 (e.g., a keyboard), a cursor control device 614 (e.g., a mouse), a drive unit 616, a signal generation device 618 (e.g., a speaker) and a network interface device 620.

In one embodiment, the video display 610 includes a touch sensitive screen for user input. In one embodiment, the touch sensitive screen is used instead of a keyboard and mouse. The disk drive unit 616 includes a machine-readable medium 622 on which is stored one or more sets of instructions 624 (e.g., software) embodying any one or more of the methodologies or functions described herein. The instructions 624 can also reside, completely or at least partially, within the main memory 604 and/or within the processor 602 during execution thereof by the computer system 600. The instructions 624 can further be transmitted or received over a network 640 via the network interface device 620. In some embodiments, the machine-readable medium 622 also includes a database 625.

Volatile RAM may be implemented as dynamic RAM (DRAM), which requires power continually in order to refresh or maintain the data in the memory. Non-volatile memory is typically a magnetic hard drive, a magnetic optical drive, an optical drive (e.g., a DVD RAM), or other type of memory system that maintains data even after power is removed from the system. The non-volatile memory 606 may also be a random access memory. The non-volatile memory 606 can be a local device coupled directly to the rest of the components in the computer system 600. A non-volatile memory that is remote from the system, such as a network storage device coupled to any of the computer systems described herein through a network interface such as a modem or Ethernet interface, can also be used.

While the machine-readable medium 622 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. Examples of machine-readable media (or computer-readable media) include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 600 to perform any one or more of the processes and features described herein.

In general, routines executed to implement the embodiments of the invention can be implemented as part of an operating system or a specific application, component, program, object, module or sequence of instructions referred to as “programs” or “applications.” For example, one or more programs or applications can be used to execute any or all of the functionality, techniques, and processes described herein. The programs or applications typically comprise one or more instructions set at various times in various memory and storage devices in the machine and that, when read and executed by one or more processors, cause the computing system 600 to perform operations to execute elements involving the various aspects of the embodiments described herein.

The executable routines and data may be stored in various places, including, for example, ROM, volatile RAM, non-volatile memory, and/or cache memory. Portions of these routines and/or data may be stored in any one of these storage devices. Further, the routines and data can be obtained from centralized servers or peer-to-peer networks. Different portions of the routines and data can be obtained from different centralized servers and/or peer-to-peer networks at different times and in different communication sessions, or in a same communication session. The routines and data can be obtained in entirety prior to the execution of the applications. Alternatively, portions of the routines and data can be obtained dynamically, just in time, when needed for execution. Thus, it is not required that the routines and data be on a machine-readable medium in entirety at a particular instance of time.

While embodiments have been described fully in the context of computing systems, those skilled in the art will appreciate that the various embodiments are capable of being distributed as a program product in a variety of forms, and that the embodiments described herein apply equally regardless of the particular type of machine- or computer-readable media used to actually effect the distribution.

Alternatively, or in combination, the embodiments described herein can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description or discussed herein. In other instances, functional block diagrams and flow diagrams are shown to represent data and logic flows. The components of block diagrams and flow diagrams (e.g., modules, engines, blocks, structures, devices, features, etc.) may be variously combined, separated, removed, reordered, and replaced in a manner other than as expressly described and depicted herein.

Reference in this specification to “one embodiment,” “an embodiment,” “other embodiments,” “another embodiment,” “in various embodiments,” or the like means that a particular feature, design, structure, or characteristic described in connection with the embodiment is included in at least one embodiment of the disclosure. The appearances of, for example, the phrases “according to an embodiment,” “in one embodiment,” “in an embodiment,” “in various embodiments,” or “in another embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments but also variously omitted in other embodiments. Similarly, various features are described which may be preferences or requirements for some embodiments but not other embodiments.

Although embodiments have been described with reference to specific exemplary embodiments, it will be evident that the various modifications and changes can be made to these embodiments. Accordingly, the specification and drawings are to be regarded in an illustrative sense rather than in a restrictive sense. The foregoing specification provides a description with reference to specific exemplary embodiments. It will be evident that various modifications can be made thereto without departing from the broader spirit and scope as set forth in the following claims. The specification and drawings are, accordingly, to be regarded in an illustrative sense rather than a restrictive sense.

Although some of the drawings illustrate a number of operations or method steps in a particular order, steps that are not order dependent may be reordered and other steps may be combined or omitted. While some reordering or other groupings are specifically mentioned, others will be apparent to those of ordinary skill in the art and so do not present an exhaustive list of alternatives. Moreover, it should be recognized that the stages could be implemented in hardware, firmware, software, or any combination thereof.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention, both independently and as an overall system, and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising,” are intended to imply the inclusion of a stated element or step or group of elements or steps, but not the exclusion of any other element or step or group of elements or steps. Such terms should be interpreted in their most expansive forms so as to afford the applicant the broadest coverage legally permissible in accordance with the following claims.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, from a search engine, a first media item;
generating, by the computing system, from the first media item, one or more seed data items;
generating, by the computing system, a search query, wherein the search query includes one or more of the seed data items; and
providing, by the computing system, the search query to the search engine.

2. The computer-implemented method of claim 1, further comprising:
determining, by the computing system, the first media item to depict a target person.

3. The computer-implemented method of claim 1, further comprising:
providing, by the computing system, a user indication of the one or more seed data items generated for the first media item.

4. The computer-implemented method of claim 1, further comprising:
providing, by the computing system, a user indication of one or more seed data items which led to discovery of the first media item.

5. The computer-implemented method of claim 1, further comprising:
generating, by the computing system, from the first media item, an audio media item and one or more image media items.

6. The computer-implemented method of claim 1, wherein the generating the one or more seed data items comprises:
recognizing, by the computing system, within the first media item, one or more of a hand signal or a body movement; and
generating, by the computing system, a description of the one or more of the hand signal or the body movement.

7. The computer-implemented method of claim 1, further comprising:
receiving, by the computing system, from the search engine, a further media item, wherein the further media item is received in reply to the search query;
generating, by the computing system, from the further media item, one or more further seed data items;
generating, by the computing system, a further search query, wherein the further search query includes one or more of:
the seed data items generated from the first media item, or the further seed data items; and
providing, by the computing system, the further search query to the search engine.

8. The computer-implemented method of claim 7, further comprising:
determining, by the computing system, the further media item to depict a target person, wherein the further media item not include a tag identifying the target person.

9. The computer-implemented method of claim 1, further comprising:
storing, by the computing system, in a repository, the one or more seed data items generated for the first media item.

10. The computer-implemented method of claim 1, wherein the generating the search query comprises:
providing, by the computing system, to a machine learning model, one or more of the seed data items; and
receiving, by the computing system, from the machine learning model, an output, wherein the output specifies one or more seed data items.

11. A system comprising:
at least one processor; and
a memory storing instructions that, when executed by the at least one processor, cause the system to perform:
receiving, from a search engine, a first media item;
generating, from the first media item, one or more seed data items;
generating a search query, wherein the search query includes one or more of the seed data items; and
providing the search query to the search engine.

12. The system of claim 11, wherein the instructions, when executed by the at least one processor, further cause the system to perform:
determining the first media item to depict a target person.

13. The system of claim 11, wherein the instructions, when executed by the at least one processor, further cause the system to perform:
providing a user indication of one or more seed data items which led to discovery of the first media item.

14. The system of claim 11, wherein the generating the one or more seed data items comprises:
recognizing, within the first media item, one or more of a hand signal or a body movement; and
generating a description of the one or more of the hand signal or the body movement.

15. The system of claim 11, wherein the instructions, when executed by the at least one processor, further cause the system to perform:
receiving, from the search engine, a further media item, wherein the further media item is received in reply to the search query;
generating, from the further media item, one or more further seed data items;
generating a further search query, wherein the further search query includes one or more of:
the seed data items generated from the first media item, or
the further seed data items; and
providing the further search query to the search engine.

16. A non-transitory computer-readable storage medium including instructions that, when executed by at least one processor of a computing system, cause the computing system to perform a method comprising:
receiving, from a search engine, a first media item;
generating, from the first media item, one or more seed data items;
generating a search query, wherein the search query includes one or more of the seed data items; and
providing the search query to the search engine.

17. The non-transitory computer-readable storage medium of claim 16, wherein the instructions, when executed by the at least one processor of the computing system, further cause the computing system to perform:
determining the first media item to depict a target person.

18. The non-transitory computer-readable storage medium of claim 16, wherein the instructions, when executed by the at least one processor of the computing system, further cause the computing system to perform:
providing a user indication of one or more seed data items which led to discovery of the first media item.

19. The non-transitory computer-readable storage medium of claim 16, wherein the generating the one or more seed data items comprises:
recognizing, within the first media item, one or more of a hand signal or a body movement; and
generating a description of the one or more of the hand signal or the body movement.

20. The non-transitory computer-readable storage medium of claim 16, wherein the instructions, when executed by the at least one processor of the computing system, further cause the computing system to perform:
receiving, from the search engine, a further media item, wherein the further media item is received in reply to the search query;
generating, from the further media item, one or more further seed data items;
generating a further search query, wherein the further search query includes one or more of:
the seed data items generated from the first media item, or the further seed data items; and
providing the further search query to the search engine.
